(19) United States
(12) Patent Application Publication
(10) Pub. No.: US 2007/0239891 A1
(43) Pub. Date: Oct. 11, 2007

(54) Method and apparatus for point-to-multipoint distribution using pseudowires

(76) Inventors: Warren Scott Wainner, Potomac Falls, VA (US); Earl Hardin Booth III, Raleigh, NC (US); Bertrand Duvivier, Wepion (BE); Luca Martini, Denver, CO (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, WESTBOROUGH, MA, 01581, US

(21) Appl. No.: 11/398,918

(22) Filed: Apr. 6, 2006

(51) Int. Cl. G06F 15/173

(52) U.S. Cl. 709/238

(57) ABSTRACT

A method, apparatus and computer program product for providing point-to-multipoint multihop distribution using Pseudowires (PWs) is presented. Data is received at a switching provider edge (S-PE) router from an upstream originating provider edge (O-PE) router by way of a first PW, the first PW having a head-end coupled to the O-PE and a tail end coupled to the S-PE. The data received is replicated by the S-PE to at least one receiver provider edge (R-PE) router by way of a respective PW for each of the at least one R-PE, each of the respective PW between the S-PE and the R-PE having a head end coupled to the SPE and a tail end coupled to the R-PE.

### BACKGROUND

Service providers (SPs) are seeking an efficient, scalable, yet simple means of distributing multicast data. There are a number of different approaches with trade-offs for each. Historically, the SP has either provided basic transport for multicast data where the subscriber is responsible for the replication or the SP provides multicast services where replication is done on behalf of the subscriber. The former model is very inefficient, as the subscriber must replicate the data onto each transport instance built in the SP; nevertheless, the architecture is simple for the provider to support. In contrast, the multicast service is much more efficient; however, it is much more complex for the SP to operate. In both cases, scalability is constrained by bandwidth efficiency or operational complexity, respectively. An ideal solution leverages the concepts of both the multicast transport and the multicast service mitigating the extreme compromises of either solution.

### SUMMARY

Prior methods of facilitating multicast distribution typically couple the transport plane with the service plane. Examples include the use of Virtual Switch Instances (VSIs) which represent Layer 2 (L2) bridging entities where the VSI interprets the contents of the service plane, maintains a cache of the service end-point locations, and manages the state of the end-points. This architecture uses the VSI as the merging and branching point. It does require managing state of the services plane.

Another alternative is to link the services plane into a label-switching infrastructure that is mapped into point to multipoint (P2MP) Label Switching Paths (LSPs). This model requires the service plane to be linked to the Multi-Protocol Label Switch (MPLS) control plane. Typically, the MPLS control plane requires a P2MP LSP that might be based on Resource Reservation Protocol Traffic Engineering (RSVP-TE). The RSVP-TE provides the transport mechanism; however, the higher layer association of label switching to service plane switching is still required.

Conventional mechanisms such as those explained above suffer from a variety of deficiencies. These two methods do allow optimized distribution trees; however, both of the existing prior art methods require the transport provider to interact with the services plane. This is a huge impediment to deployment as the service plane typically belongs to a different provider that does not want to establish any interaction with the transport provider.

Embodiments of the invention significantly overcome such deficiencies and provide mechanisms and techniques that provide a method and apparatus for point-to-multipoint distribution using pseudowires. The presently defined architecture decouples the transport plane from the service plane enabling a more scaleable operational model. It also provides an optimized distribution tree for P2MP flows that are typical of broadcast video. The transport provider has explicit control over the merge and replication points in the network.

In a particular embodiment of a method for providing point-to-multipoint multihop distribution using Pseudowires (PWs), the method includes receiving data at a switching provider edge (S-PE) router from an upstream originating provider edge (O-PE) router by way of a first PW, the first PW having a head-end coupled to the O-PE and a tail end coupled to the S-PE. The method also includes replicating the data received by the S-PE to at least one receiver provider edge (R-PE) router by way of a respective PW for each of the at least one R-PE, each of the respective PW between the S-PE and the R-PE having a head end coupled to the SPE and a tail end coupled to the R-PE.

Other embodiments include a computer readable medium having computer readable code thereon for providing a point-to-multipoint multihop distribution using Pseudowires (PWs). The medium includes instructions for receiving data at a switching provider edge (S-PE) router from an upstream originating provider edge (O-PE) router by way of a first PW, said first PW having a head-end coupled to said O-PE and a tail end coupled to said S-PE. The medium also includes instructions for replicating said data received by said S-PE to at least one receiver provider edge (R-PE) router by way of a respective PW for each of said at least one R-PE, each of said respective PW between said S-PE and said R-PE having a head end coupled to said SPE and a tail end coupled to said R-PE.

Still other embodiments include a computerized device, configured to process all the method operations disclosed herein as embodiments of the invention. In such embodiments, the computerized device includes a memory system, a processor, communications interface in an interconnection mechanism connecting these components. The memory system is encoded with a process that provides point-to-multipoint multihop distribution using Pseudowires as explained herein that when performed (e.g. when executing) on the processor, operates as explained herein within the computerized device to perform all of the method embodiments and operations explained herein as embodiments of the invention. Thus any computerized device that performs or is programmed to perform up processing explained herein is an embodiment of the invention.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing point-to-multipoint multihop distribution using Pseudowires as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers, or on one computer alone.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices such as those manufactured by Cisco Systems, Inc. of San Jose, Calif.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 comprises a block diagram of a prior art multicast network environment;

FIG. 2 comprises a block diagram of a first environment for performing point-to-multipoint multihop distribution using Pseudowires in accordance with embodiments of the invention;

FIG. 3 comprises a block diagram of the environment of FIG. 2 with the addition of a second S-PE;

FIG. 4 comprises a block diagram of the environment of FIG. 2 with the addition of a second O-PE;

FIG. 5 comprises a block diagram of the environment of FIG. 2 with the addition of a second S-PE downstream from a first S-PE;

FIGS. 6A and 6B comprises a flow chart of a particular embodiment of a method for performing point-to-multipoint multihop distribution using Pseudowires in accordance with embodiments of the invention; and

FIG. 7 illustrates an example computer system architecture for a computer system that performs point-to-multipoint multihop distribution using Pseudowires in accordance with embodiments of the invention.

### DETAILED DESCRIPTION

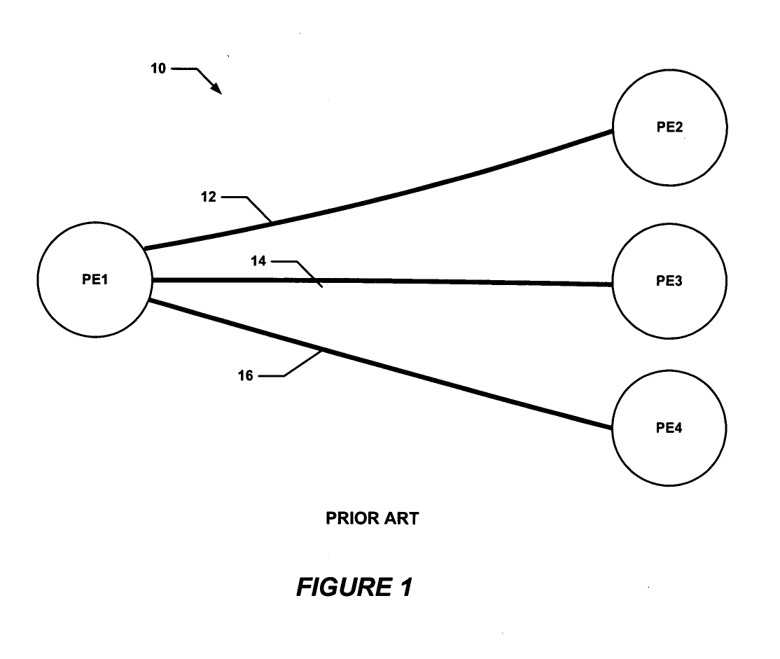

Referring to FIG. 1, a prior art multicast network environment 10 is shown. The environment 10 includes a first Provider edge (PE) router PE1, which is in communication with a plurality of other PE routers PE2-PE4. Packets received by PE1 from another network device (not shown) may be forwarded to one or more of PE2, PE3 and PE4, known as multicasting. A router typically includes a service plane used for handling the routing and signaling protocols and a transport plane for performing the packet forwarding. The service plane and the transport plane of a router are typically linked together to provide efficient routing within the environment. Historically, the provider might use virtual circuit (VC) such as a Frame Relay Permanent Viurtual Circuit (FR PVC) or Asynchronous Transfer Mode Virtual Circuit (ATM VC) as the means of transport. A first VC 12 is used to provide communication between PE1 and PE2, a second VC 14 to provide communication between PE1 and PE3 and a third VC 16 to provide communication between PE1 and PE4.

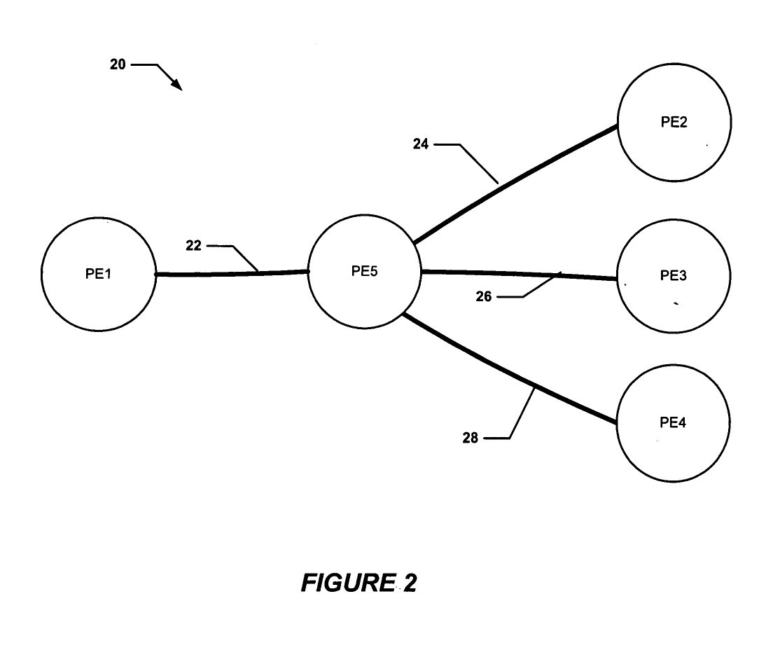

Referring now to FIG. 2, with the introduction of Layer 2 Virtual Private Networks (L2VPNs) a provider may use a PW as a means of transporting multicast data. To avoid the scalability problem at the head-end, an architecture that uses multi-hop/multi-point pseudowires is utilized. This deviates from previous L2VPN concepts that define a point-to-point PW. This model statically binds an upstream PW to one or more downstream PW.

The services plane remains disjoint from the transport plane in the sense that the PW and it's control plane have no knowledge of the multicast sources. The root of the tree is engineered to be located at the multicast source. The premise of this solution is that the multicast stream is a persistent stream that is to be replicated to all receivers. An example of this application is broadcast video where all receivers expect to receive all content any time that it is available.

Upstream is distinguished from downstream at the PW switching-PE (S-PE) by associating upstream to the content source while downstream is associated with the content receiver. Traffic that is received from an upstream PW is replicated to all the downstream PWs.

The present invention described in FIG. 2 introduces the concept of head-end and tail-end of a PW that correlate with upstream and downstream, respectively. A PW 22 is signaled between an origination PE (O-PE) (PE1) and an S-PE (PE5) where the content is sourced at the O-PE. The S-PE understands through the PW control plane that it is receiving the tail-end of the PW. Subsequently, the S-PE signals the establishment of PWs to one or more downstream receiving PE (R-PE). In this instance PW 24 is established between PE5 and PE2, PW26 is established between PE5 and PE3 and PW28 is established between PE5 and PE4. The R-PE (e.g., PE 2 and/or PE3 and/or PE4) recognizes via the control that it is also terminating a tail-end of the PW (e.g., PW 22 and/or 24 and/or 26). Architecturally, a device may operate as any device (i.e., O-PE, S-PE, or R-PE) and it's the designation on the PW configuration that defines the role of the device.

The flow model used on the multipoint multihop pseudowire is described as one-way with regards to application contact; however, the actual tree supports bidirectional flows up and down the tree. The innovation specifies that upstream flows are only merged onto the tail-end of the upstream PW while downstream flows are replicated onto the head-ends of the downstream PW. PE5 recognizes it is a branch point and needs to replicate received packets. PE5 decapsulates the received packet from the tail-end PW, replicates the packet, and subsequently encapsulates the packet into the respective head-end PW to each of PE2, PE3 and PE4. Due to the use of PWs, there is simply a layer 2 connection. No multicast state is maintained and handled by the S-PE. In fact, the payload of the PW might not even be a multicast packet. By way of the present environment 20, the transport provider is able to specify the location of SPE(s) branchpoints in order to conserve bandwidth and provide optimal utilization of the system, especially in multicast type applications such as broadcast video.

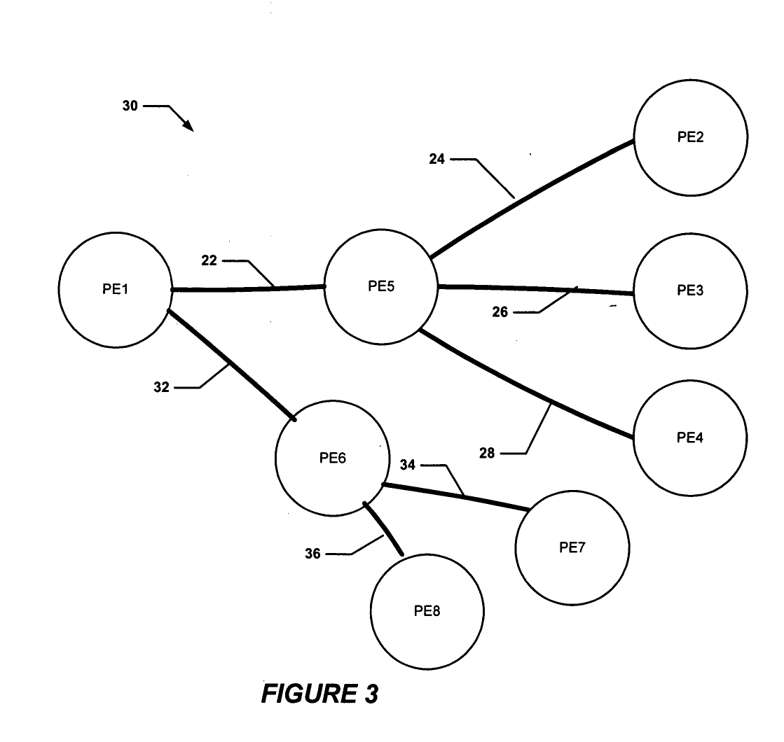

Referring now to FIG. 3, a similar environment 30 as environment 20 of FIG. 2 is shown. Environment 30 includes a PW 22 between a first origination PE (O-PE) (PE1) and an S-PE (PE5) where the content is sourced at the O-PE. The S-PE understands through the PW control plane that it receiving the tail-end of the PW. Subsequently, the S-PE signals the establishment of PWs to one or more downstream receiving PE (R-PE). In this instance PW 24 is established between PE5 and PE2, PW 26 is established between PE5 and PE3 and PW 28 is established between PE5 and PE4. The R-PE (e.g., PE 2, PE3 and/or PE4) recognizes via the control plane that it is also terminating a tail-end of the PW (e.g., PW 22, 24 and/or 26). Also shown is a second S-PE, PE6. PE6 is also in communication with PE1 by way of a PW 32. PE6 replicates packets to PE7 across PW 34 and also to PE8 via PW 36. In this environment 30, two S-PEs are used to provide replication to two groups of R-PEs.

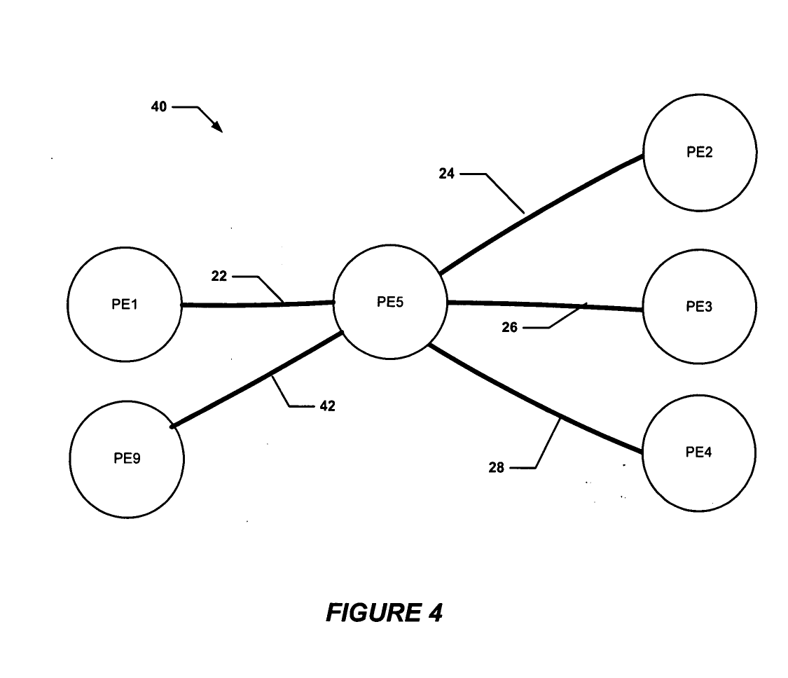

Referring now to FIG. 4 a similar environment 40 as environment 20 of FIG. 2 is shown. Environment 40 includes a PW 22 between a first origination PE (O-PE) (PE1) and an S-PE (PE5) where the content is sourced at the O-PE. A PW 22 is signaled between an origination PE (O-PE) (PE1) and an S-PE (PE5) where the content is sourced at the O-PE. The S-PE understands through the PW control plane that it is receiving the tail-end of the PW. Subsequently, the S-PE signals the establishment of PWs to one or more downstream receiving PE (R-PE). In this instance PW 24 is established between PE5 and PE2, PW 26 is established between PE5 and PE3 and PW 28 is established between PE5 and PE4. The R-PE (e.g., PE 2, PE3 and/or PE4) recognizes via the control that it is also terminating a tail-end of the PW (e.g., PW 22, 24 and/or 26). Also shown in environment 40 is a second O-PE, PE9. PE9 is in communication with PE5 by way of a PW 42. In this environment, the architecture support redundancy where two O-PE's each build a PW to an S-PE. In this case, the S-PE will have two tail-end PW's from which to receive data and replicate onto the head-ends of PW to R-PE. In this scenario, the S-PE may designate one of the tail-ends PW to the O-PE as preferred. This topological model allows the application to have redundant content feeds or to provide a backup feed in case the primary feed is lost.

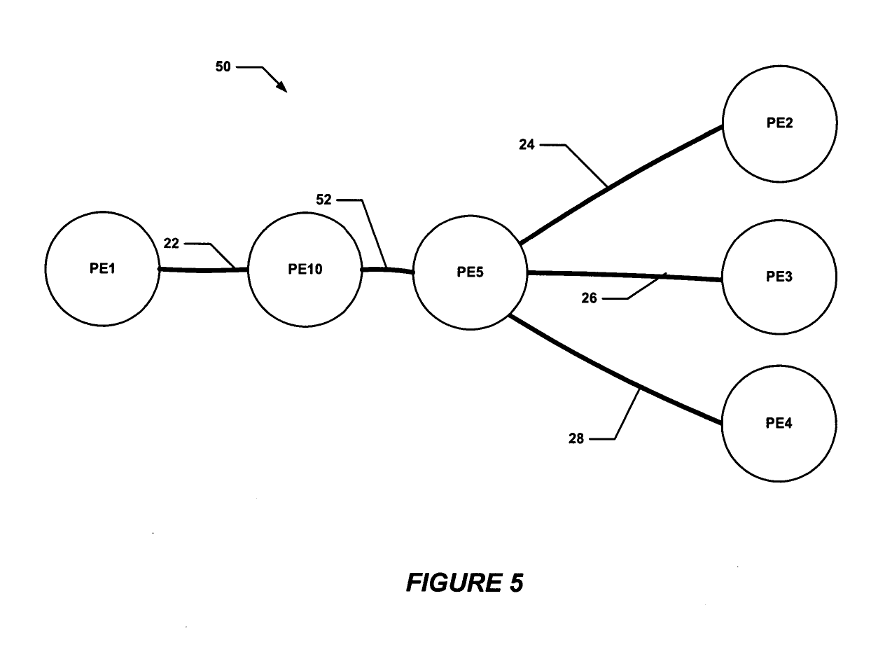

Referring now to FIG. 5, an environment 50 which facilitates hierarchy where an S-PE may feed a downstream S-PE that further replicates data onto it's attached downstream PW is shown. The provider may define a hierarchy of S-PEs in order to maintain bandwidth efficiency while minimizing operational costs. A PW 22 is signaled between an origination PE (O-PE) (PE1) and a first S-PE, PE10. The first S-PE is in communication with a second S-PE (PE5) where the content is sourced at the O-PE and switched through the cascaded S-PE. The S-PE understands through the PW control plane that it receiving the tail-end of the PW. Subsequently, the S-PE signals the establishment of PWs to one or more downstream receiving PE (R-PE). In this instance PW 24 is established between PE5 and PE2, PW 26 is established between PE5 and PE3 and PW 28 is established between PE5 and PE4. The R-PE (e.g., PE 2, PE3 and/or PE4) recognizes via the control that it is also terminating a tail-end of the PW (e.g., PW 22, 24 and/or 26).

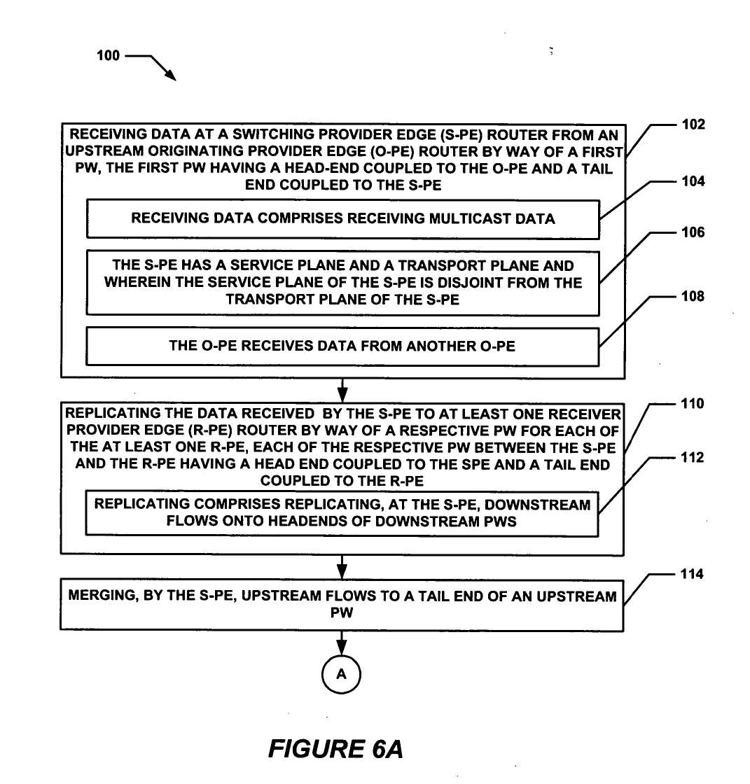

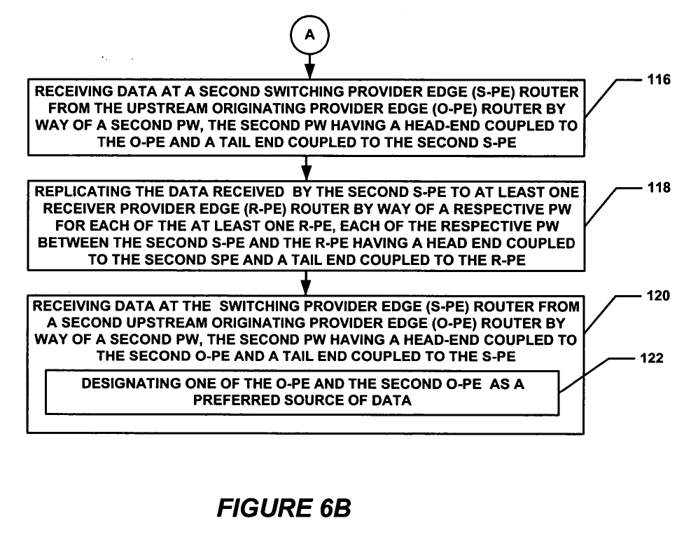

A flow chart of a particular embodiment of the presently disclosed method for point-to-multipoint distribution using pseudowires is depicted in FIGS. 6A and 6B. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIGS. 6A and 6B, the method 100 begins with processing block 102 which recites receiving data at a switching provider edge (S-PE) router from an upstream originating provider edge (O-PE) router by way of a first PW, the first PW having a head-end coupled to the O-PE and a tail end coupled to the S-PE. Processing block 104 discloses the receiving data comprises receiving multicast data. Processing block 106 discloses the S-PE has a service plane and a transport plane and wherein the service plane of the S-PE is disjoint from the transport plane of the S-PE. In certain embodiment, as recited by processing block 108, the O-PE can receive data from another O-PE.

Processing block 110 states replicating the data received by the S-PE to at least one receiver provider edge (R-PE) router by way of a respective PW for each of the at least one R-PE, each of the respective PW between the S-PE and the R-PE having a head end coupled to the SPE and a tail end coupled to the R-PE. As recited in processing block 112, the replicating comprises replicating, at the S-PE, downstream flows onto headends of downstream PWs.

Processing block 114 discloses merging, by the S-PE, upstream flows to a tail end of an upstream PW. Processing block 116 states receiving data at a second switching provider edge (S-PE) router from the upstream originating provider edge (O-PE) router by way of a second PW, the second PW having a head-end coupled to the O-PE and a tail end coupled to the second S-PE.

Processing block 118 recites replicating the data received by the second S-PE to at least one receiver provider edge (R-PE) router by way of a respective PW for each of the at least one R-PE, each of the respective PW between the second S-PE and the R-PE having a head end coupled to the second SPE and a tail end coupled to the R-PE.

Processing block 120 discloses receiving data at the switching provider edge (S-PE) router from a second upstream originating provider edge (O-PE) router by way of a second PW, the second PW having a head-end coupled to the second O-PE and a tail end coupled to the S-PE. In this scenario, as recited in processing block 122, one of the O-PE and the second O-PE can be designated as a preferred source of data.

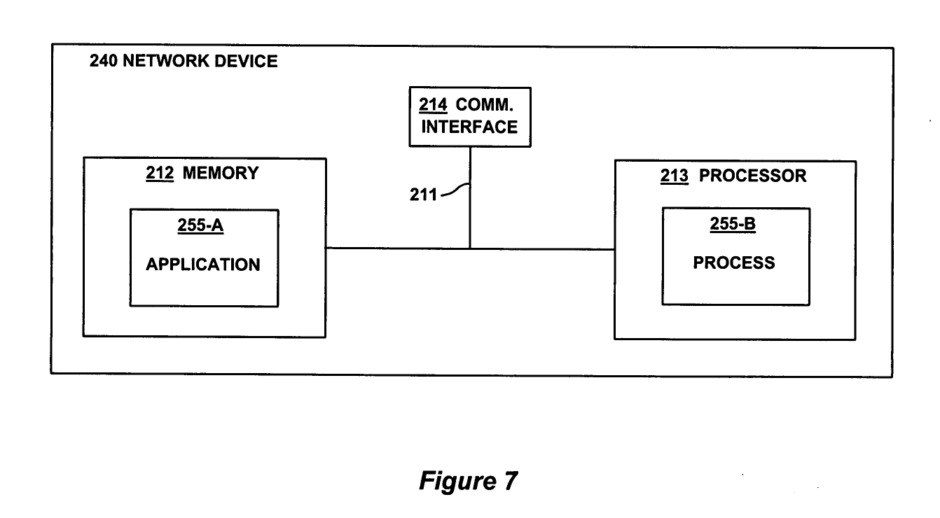

FIG. 7 illustrates example architectures of a computer system that is configured as a network device 240. In this example, the network device 240 includes an interconnection mechanism 211 that couples a memory system 212, a processor 213, and a communications interface 214. The communications interface 214 allows the network device 240 to communicate with external devices or systems.

The memory system 212 may be any type of computer readable medium that is encoded with an application 255-A that represents software code such as data and/or logic instructions (e.g., stored in the memory or on another computer readable medium such as a disk) that embody the processing functionality of embodiments of the invention as explained above. The processor 213 can access the memory system 212 via the interconnection mechanism 211 in order to launch, run, execute, interpret or otherwise perform the logic instructions of the applications 255-A for the network device in order to produce a corresponding process 255-B. In other words, the process 255-B represents one or more portions of the application 255-A performing within or upon the processor 213 in the network device.

The architectural innovation facilitates an efficient traffic replication model for P2MP while simplifying operational complexities. The transport provider is able to specify the optimal fan-out points in the network in order to conserve bandwidth. The application in the services plane is decoupled from the transport plane minimizing the interaction the transport provider and the service provider.

It is to be understood that embodiments of the invention include the applications (i.e., the un-executed or non-performing logic instructions and/or data) encoded within a computer readable medium such as a floppy disk, hard disk or in an optical medium, or in a memory type system such as in firmware, read only memory (ROM), or, as in this example, as executable code within the memory system 212 (e.g., within random access memory or RAM). It is also to be understood that other embodiments of the invention can provide the applications operating within the processor 213 as the processes. While not shown in this example, those skilled in the art will understand that the computer system may include other processes and/or software and hardware components, such as an operating system, which have been left out of this illustration for ease of description of the invention.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A method of providing point-to-multipoint multihop distribution using Pseudowires (PWs) comprising:
receiving data at a switching provider edge (S-PE) router from an upstream originating provider edge (O-PE) router by way of a first PW, said first PW having a head-end coupled to said O-PE and a tail end coupled to said S-PE;
replicating said data received by said S-PE to at least one receiver provider edge (R-PE) router by way of a respective PW for each of said at least one R-PE, each of said respective PW between said S-PE and said R-PE having a head end coupled to said SPE and a tail end coupled to said R-PE.

2. The method of claim 1 wherein said S-PE has a service plane and a transport plane and wherein said service plane of said S-PE is disjoint from the transport plane of said S-PE.

3. The method of claim 1 further comprising merging, by said S-PE, upstream flows to a tail end of an upstream PW.

4. The method of claim 1 wherein said replicating comprises replicating, at said S-PE, downstream flows onto headends of downstream PWs.

5. The method of claim 1 wherein said receiving data comprises receiving multicast data.

6. The method of claim 1 further comprising receiving data at a second switching provider edge (S-PE) router from the upstream originating provider edge (O-PE) router by way of a second PW, said second PW having a head-end coupled to said O-PE and a tail end coupled to said second S-PE; and
replicating said data received by said second S-PE to at least one receiver provider edge (R-PE) router by way of a respective PW for each of said at least one R-PE, each of said respective PW between said second S-PE and said R-PE having a head end coupled to said second SPE and a tail end coupled to said R-PE.

7. The method of claim 1 further comprising receiving data at the switching provider edge (S-PE) router from a second upstream originating provider edge (O-PE) router by way of a second PW, said second PW having a head-end coupled to said second O-PE and a tail end coupled to said S-PE.

8. The method of claim 7 further comprising designating one of said O-PE and said second O-PE as a preferred source of data.

9. The method of claim 1 wherein said O-PE receives data from another O-PE.

10. A computer system comprising:
an originating provider edge router:
a switching provider edge (S-PE) router in communication with said O-PE by way of a first Pseudowire (PW) said first PW having a head end at said O-PE and a tail end at said S-PE;
at least one receiver provider edge (R-PE) router in communication with said S-PE by way of a respective PW for each of said at least one R-PE, each of said respective PWs between said S-PE and said R-PE having a head end coupled to said SPE and a tail end coupled to said R-PE and
wherein said S-PE comprises:
a memory;
a processor;
a communications interface;
an interconnection mechanism coupling the memory, the processor and the communications interface; and
wherein the memory is encoded with a point to multipoint multihop distribution using Pseudowires application that when performed on the processor, provides a process for processing information, the process causing the SP-E to perform the operations of:
receiving data at the switching provider edge (S-PE) router from the upstream originating provider edge (O-PE) router by way of the first PW; and
replicating said data received by said S-PE to at least one receiver provider edge (R-PE) router by way of a respective PW for each of said at least one R-PE.

11. The computer system of claim 10 wherein said S-PE includes a service plane and a transport plane and wherein said service plane of said S-PE is disjoint from the transport plane of said S-PE.

12. The computer system of claim 10 further comprising said S-PE performing the operation of merging upstream flows to a tail end of an upstream PW.

13. The computer system of claim 10 wherein said replicating comprises replicating, at said S-PE, downstream flows onto headends of downstream PWs.

14. The computer system of claim 10 wherein said receiving data comprises receiving multicast data.

15. The computer system of claim 10 further comprising a second switching provider edge (S-PE) router receiving data from the upstream originating provider edge (O-PE) router by way of a second PW, said second PW having a head-end coupled to said O-PE and a tail end coupled to said second S-PE, and wherein said second S-PE performs the operations of replicating said data received by said second S-PE to at least one receiver provider edge (R-PE) router by way of a respective PW for each of said at least one R-PE, each of said respective PW between said second S-PE and said R-PE having a head end coupled to said second SPE and a tail end coupled to said R-PE.

16. The computer system of claim 10 further comprising a second upstream originating provider edge (O-PE) router providing data at the switching provider edge (S-PE) router by way of a second PW, said second PW having a head-end coupled to said second O-PE and a tail end coupled to said S-PE.

17. The computer system of claim 15 wherein one of said O-PE and said second O-PE are designated as a preferred source of data.

18. The computer system of claim 10 further comprising a second O-PE in communication with said first O-PE by way of a second Pseudowire (PW) said second PW having a head end at said second O-PE and a tail end at first O-PE;

19. A computer readable medium having computer readable code thereon for providing a point-to-multipoint multihop distribution using Pseudowires (PWs), the medium comprising:
instructions for receiving data at a switching provider edge (S-PE) router from an upstream originating provider edge (O-PE) router by way of a first PW, said first PW having a head-end coupled to said O-PE and a tail end coupled to said S-PE; and
instructions for replicating said data received by said S-PE to at least one receiver provider edge (R-PE) router by way of a respective PW for each of said at least one R-PE, each of said respective PW between said S-PE and said R-PE having a head end coupled to said SPE and a tail end coupled to said R-PE.

20. The computer readable medium of claim 18 further comprising:
instructions for merging, by said S-PE, upstream flows to a tail end of an upstream PW; and
instructions for replicating, at said S-PE, downstream flows onto headends of downstream PWs.
